(19) United States
(12) Patent Application Publication
(10) Pub. No.: US 2008/0007502 A1
(43) Pub. Date: Jan. 10, 2008

(54) Liquid Crystal Display Bias Generator

(75) Inventors: James E. Bartling, Chandler, AZ (US); Asif Iqbal, Bangalore (IN); Murugesan Raman, Bangalore (IN)

Correspondence Address: Baker Botts L.L.P.;attention of: Paul N. Katz, One Shell Plaza, 910 Louisiana Street, Houston, TX, 77002-4995, US

(73) Assignee: Microchip Technology Incorporated

(21) Appl. No.: 11/533,421

(22) Filed: Sep. 20, 2006

(30) Foreign Application Priority Data
Jul. 7, 2006 (IN) 1596/DEL/2006

(51) Int. Cl. G09G 3/36

(52) U.S. Cl. 345/87

(57) ABSTRACT

A liquid crystal display (LCD) bias generator generates a plurality of bias voltages, e.g., four bias voltages, needed to drive a segmented LCD. The LCD bias generator has a voltage generator, e.g., charge pump, that may generate a most positive voltage, e.g., substantially equal to or more positive than V_{DD}, on the integrated circuit that may also be used for maintaining proper reverse bias operation of well ties and analog switches of the integrated circuit. Other necessary LCD bias voltages, e.g., three voltages, may also be derived from the LCD bias generator to provide bias and contrast control voltages required by the LCD. Having a more positive bias voltage than the power supply voltage, V_{DD}, allows V_{DD} to cover a wider range of voltages, e.g., powered from a battery, by eliminating the need for complex analog switch and pad designs for the integrated circuit.

### CROSS REFERENCE TO RELATED APPLICATION

This application claims priority to Indian Patent Application No. 1596/DEL/2006, which was filed on Jul. 7, 2006, entitled “Liquid Crystal Display Bias Generator,” and is hereby incorporated by reference herein for all purposes.

### TECHNICAL FIELD

The present disclosure relates to liquid crystal displays, and more particularly, to a liquid crystal display bias generator.

### BACKGROUND

Present technology liquid crystal display (LCD) bias generators fabricated on integrated circuits generally use charge pumps to generate the necessary bias voltages for operation of the LCD. However, the charge pump outputs used for the LCD bias voltages may be greater or lesser than power supply, V_{DD}, to the integrated circuit. By not knowing the exact relationship between power supply V_{DD} and the LCD bias voltages, complex well ties, level-shifters and complex switching may be required for proper operation of the integrated circuit LCD bias generator. This may cause problems in the design of the integrated circuit pads, e.g., floating pads may be required, and special analog switch circuitry may be needed so that normally reverse biased junctions are not undesirably forward biased.

### SUMMARY

Therefore there is a need for an LCD bias generator that may be used in generating a plurality of bias voltages, e.g., four bias voltages, needed to drive a segmented LCD. The LCD bias generator has a voltage generator, e.g., charge pump, that may generate a most positive voltage, e.g., substantially equal to or more positive than V_{DD}, on the integrated circuit and may also be used for maintaining proper reverse bias operation of well ties and analog switches of the integrated circuit. Other necessary LCD bias voltages, e.g., three voltages, may also be derived from the LCD bias generator and may be used to provide bias and contrast control voltages required by the LCD. This allows V_{DD} to cover a wider range of voltages, e.g., powered from a battery, by eliminating the need for complex analog switch and pad designs for the integrated circuit.

According to a specific example embodiment of this disclosure, a liquid crystal displace (LCD) bias voltage generator may comprise: a first voltage generator having an input and an output; a first adjustable voltage divider coupled to the input of the first voltage generator, a power supply common and a voltage reference; a first capacitor; a pair of first switches coupling the first capacitor to the output of the first voltage generator and the power supply common when closed and decoupling the first capacitor therefrom when open; a second voltage generator having an input and an output a second adjustable voltage divider coupled to the input of the second voltage generator, the power supply common and the voltage reference; the second voltage generator output coupled to a first LCD bias voltage node and generating a first LCD bias voltage thereon; a pair of second switches coupling the first capacitor to the first LCD bias voltage node and a second LCD bias voltage node when closed and decoupling the first capacitor therefrom when open; a pair of third switches coupling the first capacitor to the second LCD bias voltage node and a third LCD bias voltage node when closed and decoupling the first capacitor therefrom when open; a pair of fourth switches coupling the first capacitor to the third LCD bias voltage node and a fourth LCD bias voltage node when closed and decoupling the first capacitor therefrom when open, wherein a second LCD bias voltage on the second LCD bias voltage node is a sum of the first LCD bias voltage and a first boost voltage on the first capacitor, a third LCD bias voltage on the third LCD bias voltage node is a sum of the first LCD bias voltage, the second LCD bias voltage and a second boost voltage on the first capacitor, and a fourth LCD bias voltage on the fourth LCD bias voltage node is a sum of the first LCD bias voltage, the second LCD bias voltage, the third LCD bias voltage and a third boost voltage on the first capacitor.

According to another specific example embodiment of this disclosure, a liquid crystal display (LCD) bias voltage generator may comprise: a voltage generator having an input and an output; an adjustable voltage divider coupled to the input of the voltage generator, a power supply common and a voltage reference; a voltage boost capacitor; a pair of voltage boost switches coupling the voltage boost capacitor to the output of the voltage generator and the power supply common when closed and decoupling the voltage boost capacitor therefrom when open; a plurality of LCD bias voltage nodes; a plurality of LCD bias voltage capacitors, each of the plurality of LCD bias voltage capacitors coupled to a respective one of the plurality of LCD bias voltage nodes and to the power supply common; a plurality of LCD bias voltage node switch pairs coupling the voltage boost capacitor between adjacent ones of the plurality of LCD bias voltage nodes when closed and decoupling the voltage boost capacitor therefrom when open, wherein a first one of the plurality of LCD bias voltage capacitors is charged to a first voltage from the voltage boost capacitor such that the respective one of the plurality of LCD bias voltage nodes is at the first voltage, a subsequent one of the plurality of LCD bias voltage capacitors is charged to a sum of the voltage on the voltage boost capacitor and the voltage on the previous one of the plurality of LCD bias voltage capacitors such that each subsequent one of the plurality of LCD bias voltage nodes has a more positive bias voltage value than the previous one of the plurality of LCD bias voltage nodes.

According to yet another specific example embodiment of this disclosure, a digital system having liquid crystal display (LCD) bias voltage generator may comprise: a digital device fabricated on an integrated circuit; a liquid crystal display (LCD) bias voltage generator fabricated on the integrated circuit, said LCD bias voltage generator comprising: a voltage generator having an input and an output; an adjustable voltage divider coupled to the input of the voltage generator, a power supply common and a voltage reference; a voltage boost capacitor; a pair of voltage boost switches coupling the voltage boost capacitor to the output of the voltage generator and the power supply common when closed and decoupling the voltage boost capacitor therefrom when open; a plurality of LCD bias voltage nodes; a plurality of LCD bias voltage capacitors, each of the plurality of LCD bias voltage capacitors coupled to a respective one of the plurality of LCD bias voltage nodes and to the power supply common; a plurality of LCD bias voltage node switch pairs coupling the voltage boost capacitor between adjacent ones of the plurality of LCD bias voltage nodes when closed and decoupling the voltage boost capacitor therefrom when open, wherein a first one of the plurality of LCD bias voltage capacitors is charged to a first voltage from the voltage boost capacitor such that the respective one of the plurality of LCD bias voltage nodes is at the first voltage, a subsequent one of the plurality of LCD bias voltage capacitors is charged to a sum of the voltage on the voltage boost capacitor and the voltage on the previous one of the plurality of LCD bias voltage capacitors such that each subsequent one of the plurality of LCD bias voltage nodes has a more positive bias voltage value than the previous one of the plurality of LCD bias voltage nodes.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of a digital device having a liquid crystal display (LCD) driver and an LCD coupled thereto;

FIG. 2 is a more detailed schematic diagram of a bias generator for the LCD driver, according to a specific example embodiment of this disclosure; and

FIG. 3 is a more detailed schematic diagram of a bias generator for the LCD driver, according to another specific example embodiment of this disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

Referring now to the drawings, the details of example embodiments are schematically illustrated. Like elements in the drawings will be represented by like numbers, and similar elements will be represented by like numbers with a different lower case letter suffix.

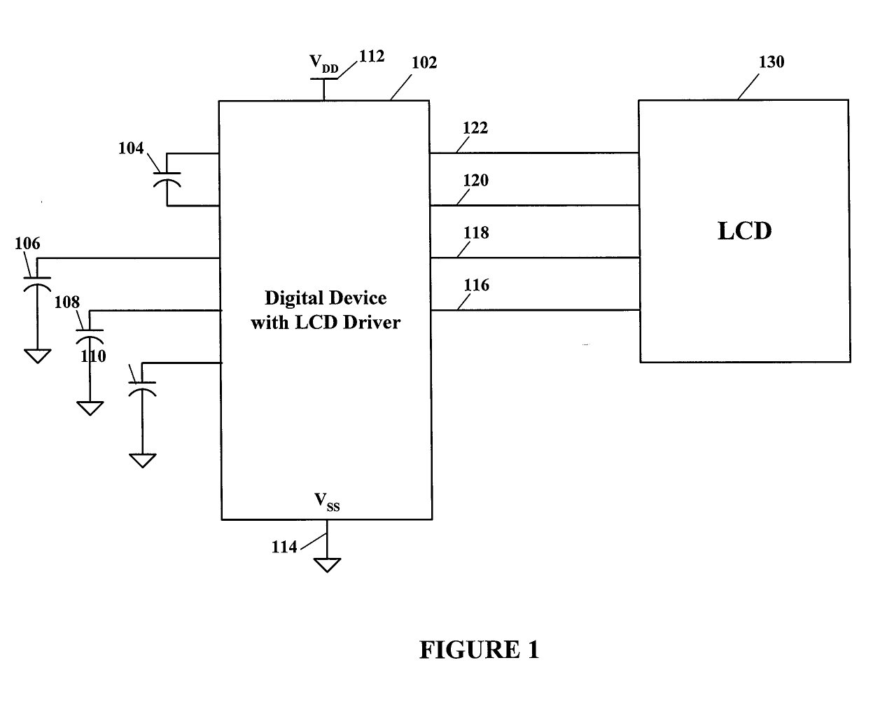

Referring to FIG. 1, depicted is a schematic block diagram of a digital device having a liquid crystal display (LCD) driver and an LCD coupled thereto. A digital device 102, e.g., microprocessor, microcontroller, digital signal processor (DSP), application specific integrated circuit (ASIC), programmable logic array (PLA), etc., may have a LCD driver integral with the digital device and fabricated on an integrated circuit die (not shown). The LCD driver of the digital device 102 may generate LCD bias voltages 116, 118, 120 and 122. These LCD bias voltages 116, 118, 120 and 122 may be used to drive display segments and control contrast of the LCD 130. The digital device 102 may be powered from a power supply voltage 112, V_{DD}, and a power supply common 114, V_{SS}. At least one of the LCD bias voltages, e.g., LCD bias voltage 122, may be more positive than the power supply voltage 112, V_{DD}. Using a LCD bias voltage that is more positive than the power supply voltage 112, V_{DD}, may be used for maintaining proper reverse bias operation of well ties and analog switches of the integrated circuit, thus allowing V_{DD} to cover a wider range of voltages, e.g., powered from a battery, by eliminating the need for complex analog switch and pad designs for the integrated circuit.

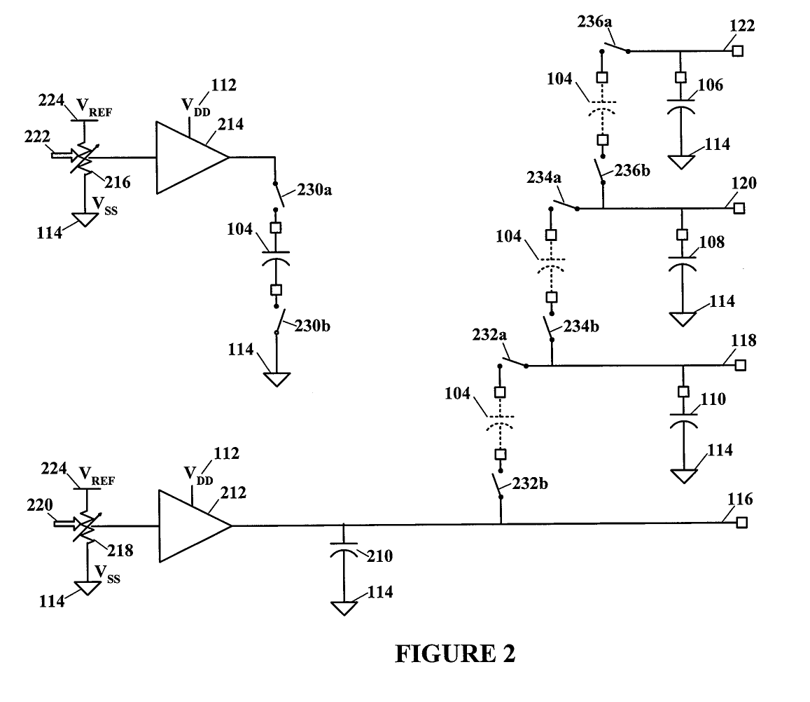

Referring now to FIG. 2, depicted is a more detailed schematic diagram of a bias generator for the LCD driver, according to a specific example embodiment of this disclosure. A first voltage generator 214, e.g., first charge pump, may be used to generate voltages across capacitor 104. Whenever switches 230a and 230b are closed, the first voltage generator 214 may charge the capacitor 104 to a voltage determined by a programmable adjustable voltage divider 216. The first voltage generator 214 may have gain that may multiply the input voltage from the adjustable voltage divider 216 to a greater amplitude output voltage, e.g., what is applied to the capacitor 104. A reference voltage 224, e.g., from a bandgap voltage reference (not shown), may be applied to the adjustable voltage divider 216. The adjustable voltage divider 216 may be digitally programmed over a first voltage adjustment reference bus 222. Thus, a plurality of different voltages may be applied to the capacitor 104 depending on LCD bias voltage requirements as more fully discussed herein.

A second voltage generator 212, e.g., second charge pump, may be used to generate certain voltages desired for the LCD bias voltage 116. The capacitor 210 may be used for voltage waveform smoothing and transient reduction. The second voltage generator 212 may have an output voltage determined by a programmable adjustable voltage divider 218. The second voltage generator 212 may have gain that may multiply the input voltage from the adjustable voltage divider 218 to a greater amplitude output voltage, e.g., what is applied as the LCD bias voltage 116. The reference voltage 224, e.g., from the bandgap voltage reference (not shown), may be applied to the adjustable voltage divider 218. The adjustable voltage divider 218 may be digitally programmed over a second voltage adjustment reference bus 220. Thus, a plurality of different voltages may be generated depending upon the LCD bias voltage 116 requirements as more fully discussed herein.

The LCD bias voltage 116 may be the lowest voltage of the LCD bias voltages. The LCD bias voltage 116 may be any voltage programmed on the second voltage adjustment reference bus 220, however, as an example but without limitation from this example, the LCD bias voltage 116 may be about 0.54 volts and the voltage across the capacitor 104 may be about 1.02 volts, hereinafter referred to as the “LCD boost voltage.” The reference voltage 224 may be about 1.2 volts, and with that reference voltage 224 the LCD bias voltage 116 may be set at any value from about zero volts to about 1 volt.

Once the LCD bias voltage 116 has been generated from the second voltage generator 212, as programmed over the second voltage adjustment reference bus 220, and a voltage generated on the capacitor 104, i.e., switches 230a and 230b are closed, the LCD bias voltage 118 may be generated by opening switches 230a and 230b, and closing switches 232a and 232b. From the example voltages above, when the LCD bias voltage 116 is about 0.54 volts and the LCD boost voltage (voltage across capacitor 104) is about 1.02 volts, the LCD bias voltage 118 will be the sum thereof, i.e., about 1.56 volts. Capacitor 110 will then charge to and hold the LCD bias voltage 118 at about 1.56 volts. Switches 232a and 232b may be opened and the LCD bias voltage 118 will remain at about 1.56 volts across the capacitor 110.

In a similar fashion to generate the LCD bias voltage 120, the LCD boost voltage may be regenerated across the capacitor 104 by closing switches 230a and 230b and applying a voltage from the first voltage generator 214 as programmed over the first voltage adjustment reference bus 222. In the present example, the LCD boost voltage may be about 1.02 volts and the LCD bias voltage 118 may be about 1.56 volts across the capacitor 110. When switches 230a and 230b open, and switches 234a and 234b close, the LCD bias voltage 120 will be the sum of the LCD bias voltage 118 at about 1.56 volts and the LCD boost voltage (voltage across capacitor 104) at about 1.02 volts. Capacitor 108 will then charge to and hold the LCD bias voltage 120 at about 2.58 volts. Switches 234a and 234b may be opened and the LCD bias voltage 120 will remain at about 2.58 volts across the capacitor 108.

The LCD bias voltage 122 (the most positive voltage of the digital device 102), may be generated with the LCD boost voltage being regenerated across the capacitor 104 by closing switches 230a and 230b and applying a voltage from the first voltage generator 214 as programmed over the first voltage adjustment reference bus 222. In the present example, the LCD boost voltage may be about 1.02 volts and the LCD bias voltage 120 may be about 2.58 volts across the capacitor 108. When switches 230a and 230b open, and switches 236a and 236b close, the LCD bias voltage 120 will be the sum of the LCD bias voltage 120 at about 2.58 volts and the LCD boost voltage (voltage across capacitor 104) at about 1.02 volts. Capacitor 106 will then charge to and hold the LCD bias voltage 122 at about 3.60 volts. Switches 236a and 2326b may be opened and the LCD bias voltage 122 will remain at about 3.60 volts across the capacitor 106.

It is contemplated and within the scope of the present disclosure that the LCD boost voltage (voltage across the capacitor 104 may be any voltage that may be programmed over the first voltage adjustment reference bus 222. The LCD bias voltage 116 may be any voltage that may be programmed over the second voltage adjustment reference bus 220. The LCD bias voltage 120 may be the sum of the LCD bias voltage 118 and the LCD boost voltage. The LCD bias voltage 122 may be the sum of the LCD bias voltage 120 and the LCD boost voltage. The LCD bias voltage 122 (most positive) may be the sum of the LCD bias voltage 120 and the LCD boost voltage.

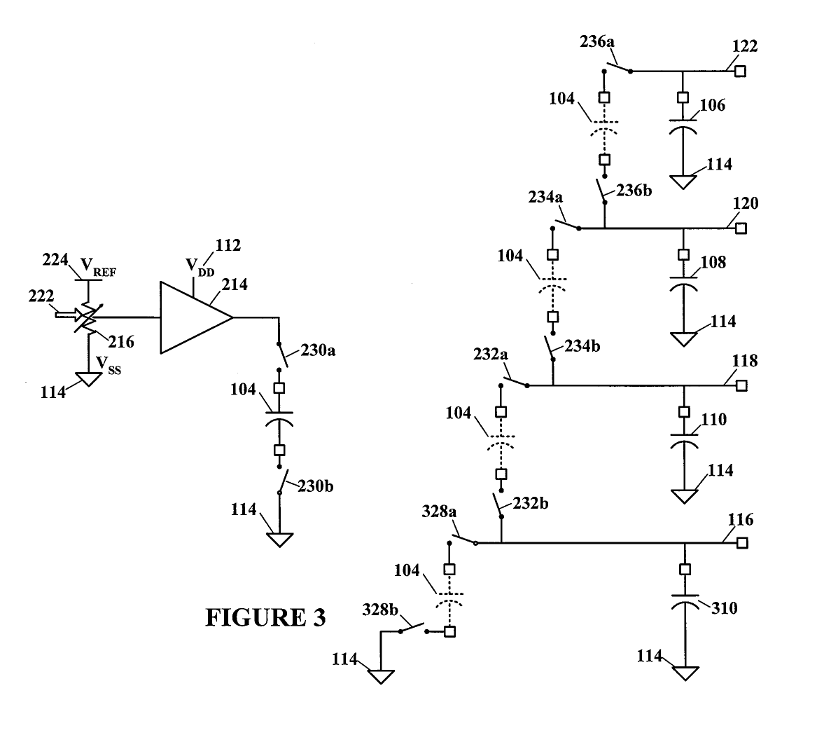

Referring now to FIG. 3, depicted is a more detailed schematic diagram of another bias generator for the LCD driver, according to a specific example embodiment of this disclosure. An LCD bias generator 214, e.g., charge pump, may be used to generate voltages across capacitor 104. Whenever switches 230a and 230b are closed, the LCD bias generator 214 may charge the capacitor 104 to a voltage determined by a programmable adjustable voltage divider 216. The LCD bias generator 214 may have gain that may multiply the input voltage from the adjustable voltage divider 216 to a greater amplitude output voltage, e.g., what is applied to the capacitor 104. A reference voltage 224, e.g., from a bandgap voltage reference (not shown), may be applied to the adjustable voltage divider 216. The adjustable voltage divider 216 may be digitally programmed over a voltage adjustment reference bus 222. Thus, a plurality of different voltages may be applied to the capacitor 104 depending on LCD bias voltage requirements as more fully discussed herein.

To generate the LCD bias voltage 116, a first voltage may be generated across the capacitor 104 by closing switches 230a and 230b. The first voltage may be defined by what voltage is programmed into the adjustable voltage divider 216 through the voltage adjustment reference bus 222. When switches 230a and 230b open, and switches 328a and 328b close, the LCD bias voltage 116 will be at the first voltage. Capacitor 310 will then charge to and hold the LCD bias voltage 116 at about the first voltage. Switches 328a and 328b may be opened and the LCD bias voltage 116 will remain at about the first voltage across the capacitor 310.

To generate the LCD bias voltage 118, a second voltage may be generated across the capacitor 104 by closing switches 230a and 230b. The second voltage may be defined by what voltage is programmed into the adjustable voltage divider 216 through the voltage adjustment reference bus 222. When switches 230a and 230b open, and switches 232a and 232b close, the LCD bias voltage 118 will be the sum of the second voltage and the first voltage (LCD bias voltage 116). Capacitor 110 will then charge to and hold the LCD bias voltage 118 at about the sum of the first and second voltages. Switches 232a and 232b may be opened and the LCD bias voltage 118 will remain at about the sum of the first and second voltages across the capacitor 110.

To generate the LCD bias voltage 120, a third voltage may be generated across the capacitor 104 by closing switches 230a and 230b. The third voltage may be defined by what voltage is programmed into the adjustable voltage divider 216 through the voltage adjustment reference bus 222. When switches 230a and 230b open, and switches 234a and 234b close, the LCD bias voltage 120 will be the sum of the third, second and first voltages. Capacitor 108 will then charge to and hold the LCD bias voltage 118 at about the sum of the first, second and third voltages. Switches 234a and 234b may be opened and the LCD bias voltage 120 will remain at about the sum of the first, second and third voltages across the capacitor 108.

To generate the LCD bias voltage 122, a fourth voltage may be generated across the capacitor 104 by closing switches 230a and 230b. The fourth voltage may be defined by what voltage is programmed into the adjustable voltage divider 216 through the voltage adjustment reference bus 222. When switches 230a and 230b open, and switches 236a and 236b close, the LCD bias voltage 122 will be the sum of the fourth, third, second and first voltages. Capacitor 106 will then charge to and hold the LCD bias voltage 120 at about the sum of the first, second, third and fourth voltages. Switches 236a and 236b may be opened and the LCD bias voltage 122 will remain at about the sum of the first, second, third and fourth voltages across the capacitor 106.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A liquid crystal displace (LCD) bias voltage generator, comprising:
a first voltage generator having an input and an output;
a first adjustable voltage divider coupled to the input of the first voltage generator, a power supply common and a voltage reference;
a first capacitor;
a pair of first switches coupling the first capacitor to the output of the first voltage generator and the power supply common when closed and decoupling the first capacitor therefrom when open;
a second voltage generator having an input and an output;
a second adjustable voltage divider coupled to the input of the second voltage generator, the power supply common and the voltage reference;
the second voltage generator output coupled to a first LCD bias voltage node and generating a first LCD bias voltage thereon;
a pair of second switches coupling the first capacitor to the first LCD bias voltage node and a second LCD bias voltage node when closed and decoupling the first capacitor therefrom when open;
a pair of third switches coupling the first capacitor to the second LCD bias voltage node and a third LCD bias voltage node when closed and decoupling the first capacitor therefrom when open;
a pair of fourth switches coupling the first capacitor to the third LCD bias voltage node and a fourth LCD bias voltage node when closed and decoupling the first capacitor therefrom when open, wherein
a second LCD bias voltage on the second LCD bias voltage node is a sum of the first LCD bias voltage and a first boost voltage on the first capacitor,
a third LCD bias voltage on the third LCD bias voltage node is a sum of the first LCD bias voltage, the second LCD bias voltage and a second boost voltage on the first capacitor, and
a fourth LCD bias voltage on the fourth LCD bias voltage node is a sum of the first LCD bias voltage, the second LCD bias voltage, the third LCD bias voltage and a third boost voltage on the first capacitor.

2. The LCD bias voltage generator according to claim 1, wherein the first adjustable voltage divider is programmable.

3. The LCD bias voltage generator according to claim 1, wherein the second adjustable voltage divider is programmable.

4. The LCD bias voltage generator according to claim 1, further comprising a second capacitor coupled between the second LCD bias voltage node and the power supply common.

5. The LCD bias voltage generator according to claim 1, further comprising a third capacitor coupled between the third LCD bias voltage node and the power supply common.

6. The LCD bias voltage generator according to claim 1, further comprising a fourth capacitor coupled between the fourth LCD bias voltage node and the power supply common.

7. The LCD bias voltage generator according to claim 1, further comprising a fifth capacitor coupled between the first LCD bias voltage node and the power supply common.

8. The LCD bias voltage generator according to claim 1, wherein the voltage reference is a bandgap voltage reference.

9. The LCD bias voltage generator according to claim 1, wherein the first voltage generator is a charge pump.

10. The LCD bias voltage generator according to claim 1, wherein the second voltage generator is a charge pump.

11. The LCD bias voltage generator according to claim 1, wherein the fourth LCD bias voltage is substantially equal to or more positive than a power supply voltage.

12. The LCD bias voltage generator according to claim 11, wherein:
the first and second voltage generators;
the first and second adjustable voltage dividers; and
the pairs of first, second, third and fourth switches are fabricated on an integrated circuit.

13. The LCD bias voltage generator according to claim 12, wherein the fourth LCD bias voltage is coupled to well ties and analog switches of the integrated circuit.

14. The LCD bias voltage generator according to claim 13, further comprising a digital device fabricated on the integrated circuit.

15. The LCD bias voltage generator according to claim 14, wherein the digital device is selected from the group consisting of a microprocessor, a microcontroller, a digital signal processor (DSP), an application specific integrated circuit (ASIC) and a programmable logic array (PLA).

16. A liquid crystal display (LCD) bias voltage generator, comprising:
a voltage generator having an input and an output;
an adjustable voltage divider coupled to the input of the voltage generator, a power supply common and a voltage reference;
a voltage boost capacitor;
a pair of voltage boost switches coupling the voltage boost capacitor to the output of the voltage generator and the power supply common when closed and decoupling the voltage boost capacitor therefrom when open;
a plurality of LCD bias voltage nodes;
a plurality of LCD bias voltage capacitors, each of the plurality of LCD bias voltage capacitors coupled to a respective one of the plurality of LCD bias voltage nodes and to the power supply common;
a plurality of LCD bias voltage node switch pairs coupling the voltage boost capacitor between adjacent ones of the plurality of LCD bias voltage nodes when closed and decoupling the voltage boost capacitor therefrom when open, wherein
a first one of the plurality of LCD bias voltage capacitors is charged to a first voltage from the voltage boost capacitor such that the respective one of the plurality of LCD bias voltage nodes is at the first voltage,
a subsequent one of the plurality of LCD bias voltage capacitors is charged to a sum of the voltage on the voltage boost capacitor and the voltage on the previous one of the plurality of LCD bias voltage capacitors such that each subsequent one of the plurality of LCD bias voltage nodes has a more positive bias voltage value than the previous one of the plurality of LCD bias voltage nodes.

17. The LCD bias voltage generator according to claim 16, wherein the adjustable voltage divider is programmable.

18. The LCD bias voltage generator according to claim 16, wherein at least the last one of the plurality of LCD bias voltage nodes is substantially equal to or more positive than a power supply voltage.

19. The LCD bias voltage generator according to claim 18, wherein:
the voltage generator;
the adjustable voltage divider;
the pair of voltage boost switches; and
the plurality of LCD bias voltage node switch pairs are fabricated on an integrated circuit.

20. The LCD bias voltage generator according to claim 19, wherein a most positive voltage of a one of the plurality of LCD bias voltage nodes is coupled to well ties and analog switches of the integrated circuit.

21. The LCD bias voltage generator according to claim 20, further comprising a digital device fabricated on the integrated circuit.

22. The LCD bias voltage generator according to claim 21, wherein the digital device is selected from the group consisting of a microprocessor, a microcontroller, a digital signal processor (DSP), an application specific integrated circuit (ASIC) and a programmable logic array (PLA).

23. A digital system having liquid crystal display (LCD) bias voltage generator, said system comprising:
a digital device fabricated on an integrated circuit;
a liquid crystal display (LCD) bias voltage generator fabricated on the integrated circuit, said LCD bias voltage generator comprising:
a voltage generator having an input and an output;
an adjustable voltage divider coupled to the input of the voltage generator, a power supply common and a voltage reference;
a voltage boost capacitor;
a pair of voltage boost switches coupling the voltage boost capacitor to the output of the voltage generator and the power supply common when closed and decoupling the voltage boost capacitor therefrom when open;
a plurality of LCD bias voltage nodes;
a plurality of LCD bias voltage capacitors, each of the plurality of LCD bias voltage capacitors coupled to a respective one of the plurality of LCD bias voltage nodes and to the power supply common;
a plurality of LCD bias voltage node switch pairs coupling the voltage boost capacitor between adjacent ones of the plurality of LCD bias voltage nodes when closed and decoupling the voltage boost capacitor therefrom when open, wherein
a first one of the plurality of LCD bias voltage capacitors is charged to a first voltage from the voltage boost capacitor such that the respective one of the plurality of LCD bias voltage nodes is at the first voltage,
a subsequent one of the plurality of LCD bias voltage capacitors is charged to a sum of the voltage on the voltage boost capacitor and the voltage on the previous one of the plurality of LCD bias voltage capacitors such that each subsequent one of the plurality of LCD bias voltage nodes has a more positive bias voltage value than the previous one of the plurality of LCD bias voltage nodes.

24. The digital system according to claim 23, wherein the digital device is selected from the group consisting of a microprocessor, a microcontroller, a digital signal processor (DSP), an application specific integrated circuit (ASIC) and a programmable logic array (PLA).

25. The digital system according to claim 23, wherein at least the last one of the plurality of LCD bias voltage nodes is substantially equal to or more positive than a power supply voltage.

26. The digital system according to claim 25, wherein the most positive LCD bias voltage is coupled to well ties and analog switches of the integrated circuit.

27. The digital system according to claim 23, further comprising a liquid crystal display (LCD) coupled to the integrated circuit.
